(19) United States
(12) Patent Application Publication
(10) Pub. No.: US 2015/0125572 A1
(43) Pub. Date: May 7, 2015

(54) MOISTURE RESISTANT WAFER

(71) Applicant: NESTEC S.A., Vevey (CH)

(72) Inventors: Carl Erik Hansen, Epalinges (CH); Pierre Nicolas, Saint Legier (CH); Baltasar Valles Pamies, Villars-sur-glane (CH)

(21) Appl. No.: 14/560,884

(22) Filed: Dec. 4, 2014

Related U.S. Application Data
(63) Continuation of application No. 12/596,781, filed on Oct. 20, 2009, now abandoned.

(30) Foreign Application Priority Data
Apr. 20, 2007 (EP) 07106604.7

(51) Int. Cl. A21D 13/00; A23G 3/54; A23K 1/165; A21D 8/04

(52) U.S. Cl. CPC A21D 13/008; A21D 8/042; A21D 13/0035; A23G 3/545; A23K 1/1653; A23V 2002/00
USPC 426/63; 426/64

(57) ABSTRACT

The present invention relates to a moisture resistant or moisture tolerant wafer which retains its crispy texture when exposed to moisture.

### PRIORITY CLAIM

This application is a continuation of U.S. application Ser. No. 12/596,781, filed Oct. 20, 2009, which is a U.S. national stage filing of International Appl.PCT/EP08/054,792, filed on Apr. 21, 2008, which claims priority to European Patent Application No. 07106604.7, filed Apr. 20, 2007, the entire contents of which are being incorporated herein by reference.

### FIELD OF THE INVENTION

The present invention relates to a moisture resistant or moisture tolerant wafer which retains its crispy texture when exposed to moisture. In this invention “moisture resistant” and “moisture tolerant” mean the same thing and will be used interchangeably.

### BACKGROUND OF THE INVENTION

Manufacturing wafers consists in preparing a batter containing mainly flour and water to which other minor ingredients may be added. Typically 40 to 50% flour in batter is used in the manufacture of commercial flat wafers. Common formulations may also comprise at least one of the following ingredients: fat and/or oil, lecithin and/or emulsifiers, sugar, whole egg, salt, sodium bicarbonate, ammonium bicarbonate, skim milk powder, soy flour, yeast, and/or enzymes such as xylanases or proteases, for example. In the wafer manufacture, after preparation the batter is usually cooked between two heated engraved metal plates for a determined time at a certain temperature, for instance 2 min at 160° C., to produce large flat wafer sheets with a low moisture level. After cooling, the wafers are processed according to the requirements of the final product.

Wafers are baked products which are made from wafer batter and have crisp, brittle and fragile consistency. They are thin, with an overall thickness usually between <1 and 4 mm and typical product densities range from 0.1 to 0.3 g/cm³. The surfaces are precisely formed, following the surface shape of the plates between which they were baked. They often carry a pattern on one surface or on both.

Two basic types of wafer are described by K. F. Tiefenbacher in “Encyclopaedia of Food Science, Food Technology and Nutrition p 417-420—Academic Press Ltd London—1993”:

1) No—or low-sugar wafers. The finished biscuits contain from zero to a low percentage of sucrose or other sugars. Typical products are flat and hollow wafer sheets, moulded cones or fancy shapes.

2) High-sugar wafers. More than 10% of sucrose or other sugars are responsible for the plasticity of the freshly baked sheets. They can be formed into different shapes before sugar recrystallization occurs. Typical products are moulded and rolled sugar cones, rolled wafer sticks and deep-formed fancy shapes. The present invention is concerned with wafers substantially of type (1), i.e. no-or low sugar wafers, and will be described in more detail below.

No-or low sugar wafers have a different texture and taste compared to high sugar wafers. When layered with a filling, they are used as the centre of well known chocolate confectionery products such as KIT KAT®.

Wafers may be distinguished from other biscuits/cookies in that wafers are the result of baking a batter whereas biscuits/cookies are usually baked out of a dough. Batter is a liquid suspension that will flow through a pipe whereas biscuit dough is rather stiff to permit rolling and flattening and normally has a water content of less than 50 parts per 100 parts of flour.

Wafers may also be produced by extrusion, according to our European co-pending patent application No. 06018976.8.

Wafer manufacture may use enzymes, preferably endo-proteinases (such as neutral bacterial proteinase from Bacillus subtilis or papain from Carica papaya), to hydrolyse the peptide bonds in wheat gluten, having the effect to prevent gluten lumps formation, and also xylanase (pentosanase) to hydrolyse the xylan backbone in arabinoxylan (pentosan), having the effect to decrease water binding capacity of wheat pentosans, to redistribute water among other flour components and to reduce batter viscosity. Combinations of these enzymes may also be used, mainly to decrease batter viscosity, make batters more homogenous, increase machinability, allow standard flour grades to be employed and/or increase the flour level in batter. These preparations have become widely accepted (Food Marketing & Technology, April 1994, p. 14).

There are strong trends towards light and crispy “on the go” products and wafers combined with indulgent fillings are highly appreciated by the consumer. One of the main attributes of wafers is its property of crispness when used in contact with components containing contrasting textures such as creams, jams or chocolate. However, a major disadvantage is that the level of crispness usually falls when wafers absorb moisture from some of the components or the external environment. It is well known that, if the water content of a cereal wafer increases beyond a certain level, the wafer suffers a dramatic deterioration in quality, losing crispness and becoming “cardboardy” and non-brittle. As a consequence, the wafers are perceived as soggy and the final food products are undesirable to consumers.

In known attempts to overcome this problem, the water activity of fillings used in wafer products has been lowered. One method of reducing the water activity has been disclosed in EP-A-372596 which involves the addition of ingredients such as sorbitol, glycerol or polyhydric alcohols. Another method of reducing the water activity has been disclosed in EP-A-515864 which involves the addition of hydrocolloids. Yet another common method of reducing the water activity is by the addition of fat. However, these methods often suffer from flavour, taste and texture problems. In addition, they do not provide low fat-low calorie products which are increasingly desired by consumers, particularly the trend for light and crispy “on the go” products.

Another known way to increase crispness retention is by coating the wafers with edible moisture barriers to prevent the water being transferred from the filling to the wafer. Chocolate or fatty materials may be used to provide such moisture resistant layers as described, for example, in EP-A-1080643. However, these additional treatments require wafer coating by dipping, spraying, enrobing or similar methods, which seriously complicate the industrial manufacture of confectionery products. In addition, the use of chocolate or fatty materials increases the calorie content.

WO 02/39820 seeks to provide baked food products with an increased crispiness at high moisture content by the use of sweeteners such as crystalline hydrate forming sugars (such as maltose, isomaltose, trehalose, lactose and raffinose) or high molecular weight starch hydrolysates. This approach is not suitable for no or low sugar wafers which don't contain the required high levels of sweeteners.

This approach requires the use of costly ingredients (compared to flour) and has an important limitation in that the performance of high molecular weight starch hydrolysates is degraded during the batter holding time as they are progressively hydrolysed by endogenous flour enzymes. This has the effect of creating a final batter with a low Dextrose Equivalent (DE) which increases the stickiness of the wafers during baking Sticky wafers have a detrimental effect on production throughput and so require the use of higher fat levels.

EP-A-1415539 discloses a flour based food product such as a wafer produced by using a thermostable alpha-amylase to manipulate textural properties of wafers. No mention is made of moisture tolerance.

Journal of Cereal Science 43 (2006), page 349 discloses that alpha-amylase was sprayed on the surface of bread dough prior to baking to elucidate the effect of starch hydrolysis on crust crispness. However, although the alpha-amylase treatment resulted in initially crispy fresh bread, the crispness disappeared within 2 hours storage.

### SUMMARY

The present invention seeks to overcome the above disadvantages by providing moisture resistance to the wafer itself and we have surprisingly found that a no- or low sugar moisture resistant wafer which maintains its crispness in high water activity environments may be prepared by using a thermostable alpha-amylase in the batter.

The crispness of wafers may be evaluated by a penetration test (also known as a puncture test or crush test) which is performed by using a texture analyser able to record force/distance parameters during penetration of a probe into the wafer. The instrument forces a cylindrical probe into a stack of five wafers and the structural ruptures (force drops) are recorded over a certain distance. The frequency of force drops allows discrimination between wafer textures whereby the higher the number of force drops, the higher the crispness. The conditions used for this test were: Texture Analyser TA.HD, Stable Micro Systems, England; load cell 50 kg; 4 mm diameter cylinder stainless probe; penetration rate 1 mm/s; distance 8 mm; record of force drops greater than 0.2N; trigger force greater than 0.5N; acquisition rate 500 points per second. Van Hecke E. (1991), “Contribution a 1'etude des proprietes texturals des produits alimentaires alveoles. Mise an point de nouveaux capteurs. Ph.D. Thesis, Universite de Technologic de Compiegne”, proposed a method based on 4 parameters to characterise force-deformation curve. Changes in moisture tolerance may be associated to one of these parameters (crispiness work, Wc) which is defined as Crispness Work, Wc (N.mm). N.mm (Newton millimetre) is the non-SI work unit used.

$$Wc ( N \cdot mm ) = \frac{( A / d )}{( No / d )}$$

where No; total number of peaks

d; distance of penetration (mm)

A; Area under the force-deformation curve (N.mm)

The above equation could be simplified to Wc=A/No.

A standard wafer tends to lose its perceived crispness progressively as the water activity is raised above 0.3.

This loss of crispness is a continuum (continuous changes upon hydration) with many factors having an influence such as the recipe, density, geometry, etc. Using the above penetration test, we have shown that the Wc of standard wafers starts to increase as the water activity is raised from 0.1 to 0.25.

Once the water activity of a standard wafer is increased above about 0.3, an increase in water activity of 0.1 results in an increase in the Wc of the said standard wafer greater than 1.5.

### BRIEF DESCRIPTION OF THE DRAWINGS

FIG. 1 shows a graph depicting the crispiness work of standard and alpha-amylase treated wafers at various water activities.

FIG. 2 shows graphs depicting the results of sensory analysis of standard and alpha-amylase treated wafers at various water activities.

### DETAILED DESCRIPTION

A moisture resistant wafer is defined in the present invention as a wafer that maintains crispness in high water activity environments, i.e. it maintains its mechanical resistance and its initial sensory attributes when equilibrated at elevated water activity levels such that at water activities from 0.3 to 0.4, surprisingly from 0.4 to 0.5, and more surprisingly from 0.5 to 0.6 an increase of 0.1 in water activity results in a Wc increase less than 1.5.

Accordingly, the present invention provides a no- or low sugar moisture resistant wafer, characterised in that at water activities from 0.3 to 0.6, an increase of 0.1 in water activity results in a Wc increase less than 1.5, preferably less than 1.25, and more preferably less than 1.0.

In the present invention, no- or low sugar wafers are defined as wafers containing from 0 to 15% by weight sweetener, preferably from 0 to 10% by weight sweetener, more preferably from 0 to 8% by weight sweetener, and even more preferably from 0 to 5% sweetener based on the weight of the wafer. The sweetener may be sucrose or another sugar or a starch hydrolysate of any Dextrose Equivalents (DE) or an inulin hydrolysate or mixtures of two or more of these sweeteners. Examples of sugars other than sucrose are, for example, glucose, lactose, maltose or fructose and crystalline hydrate formers such as isomaltose, trehalose, or raffinose.

The wafer may also contain added enzymes such as proteinases and/or xylanases.

The wafer may be a flat wafer either having geometric shapes or cartoons character shapes, as well as alphabet letters or numbers, for example. It can also be a three dimensional shaped wafer such as, for example, a cone, a glass, a dish.

Wafer texture results from the generation of gas cells in a gel structure mainly composed of gelatinised starch. The high temperature of the baking plates induces a rapid gelatinisation of starch granules present in the flour and production and expansion of the gas bubbles inside the gelatinous matrix. These gas cells are, in the common practice, mainly generated from gassing agents such as added bicarbonates or carbon dioxide produced by gas-generating microorganisms such as yeast during batter fermentation and from steam produced by heating. Therefore the wafer can be seen as a solid foam of gelatinised and dried starch/flour with dispersed gas cells (which can form an almost continuous phase in certain cases).

One method of preparing a wafer of the present invention involves the enzymatic depolymerisation of the starch present in the flour by a thermostable alpha-amylase leading to a reduction of the molecular weight of the starch and a reduction in the starch viscosity at the baking step. Although not wishing to be bound by theory, it is thought that a viscosity drop allows gas bubbles to grow further, due to the lower viscosity of the gelatinised starch phase. The moisture-resistant wafer may be prepared by a process comprising the steps of making a batter by mixing at least flour, water and a thermostable alpha-amylase and baking it on at least one hot surface.

A batter usually comprises around 40-50% flour, for example wheat flour, which itself contains approximately 70% of starch mainly occurring in the form of granules. In some batters, starch may be added in addition to the flour. Non-damaged starch cannot be modified by amylolytic enzymes before gelatinisation, a process involving dissolution of starch molecules from the starch granules by heating.

Amylolytic enzymes can only attack starch efficiently if starch granules have entered a gelatinisation process which occurs at temperatures above about 50-60° C. In the present invention, enzymatic hydrolysis starts with starch gelatinisation between the hot baking plates using a thermostable alpha-amylase.

The alpha-amylase is preferably added to the batter at the same time as the other ingredients, and is allowed to hydrolyse starch in the oven at a temperature around 100° C. during the period of time corresponding to water evaporation. The enzyme is then progressively inactivated at the higher temperatures reached in the drying phase. The alpha-amylase can also be added to the batter just before the baking stage since the enzyme will hydrolyse gelatinised starch only in the oven.

Different alpha-amylases covering a broad range of thermostability are available on the market, such as fungal alpha-amylases having a low thermostability (55° C.-60° C.), cereal alpha-amylases having a medium thermostability (60° C.-70° C.), and bacterial alpha-amylases having a high thermostability of up to 100° C. The enzyme used is preferably of bacterial origin, is mostly active at a pH of 5 to 7 and at a temperature of about 70° C. to 105° C. For example, the enzyme can be produced from Bacillus species or any other microorganism, plant or animal, having an alpha-amylase activity.

Suitable alpha-amylase enzymes that may be used are Validase HT 340L produced by the fermentation of Bacillus subtilis having an optimum temperature of activity of 90° C.-95° C. and an effective temperature of activity of up to 100° C., and Validase BAA produced by the fermentation of Bacillus subtilis having an optimum temperature of activity of 65° C.-75° C. and an effective temperature of activity of up to 90° C., both enzymes from Valley Research.

Therefore, the moisture-resistant wafer of the present invention preferably comprises a thermostable alpha-amylase and in-situ modified starch.

The amount of thermostable alpha-amylase incorporated into the batter may be from 0.0005% to 1.0%, preferably from 0.001% to 0.5% and more preferably from 0.01% to 0.25% by weight based on the total weight of the batter.

The wafer of the present invention may, if desired, also contain a fat or oil commonly used in baked confectionery, conveniently in an amount less than 4.0%, and preferably less than 2.0% by weight based on the total weight of the wafer.

The wafers of the present invention maintain desired textural qualities such as crispness at high moisture contents and therefore exhibit an increased moisture tolerance, particularly at a water activity at 0.30 or above.

The wafer obtained can be presented to the consumer as a wafer by itself, but it can also be further processed to form a confectionery or savoury food product or a petfood where the wafer contacts another food material. Therefore, the present invention also comprises a food product comprising a moisture-resistant wafer in contact with another food material, characterised in that at water activities from 0.3 to 0.6, an increase of 0.1 in water activity results in a We increase less than 1.5, preferably less than 1.25, and more preferably less than 1.0. The other food material may be a confectionery or savoury food product or a petfood.

Preferably the wafer is in direct contact with the food material. Conventional food materials may be used and examples of suitable food materials are chocolate, jelly, compound chocolate, ice-cream, sorbet, nut paste, cream-based products, cake, mousse, nougat, caramel, praline, jam, wafer rework or a combination of these ingredients with or without inclusions of the same ingredient in a different state or of a different ingredient. For savoury products suitable food materials would include fish or meat paste, cheese-based materials or vegetable puree. Such a food product may include one or more of these other materials as fillings for the wafer. The food material may contain a high water activity. In the present invention, for a food material with a filling, after equilibration between the filling and the wafer an acceptable sensory perception may be achieved for a water activity of up to 0.65. However, the filling may have previously had a higher water activity value since it will lose moisture during the equilibration phase. For example, it is possible to make a sandwich bar composed of external layers of wafers framing the same or different fillings. The sandwich can also be a succession of a wafer and filling pair, the first and last layers being wafer, comprising from 2 to 15 wafer layers. Although the use of a moisture barrier is generally unnecessary, a moisture barrier may optionally be used if desired.

It is also possible to use the wafer as the centre or part of the centre of a confectionery or savoury product or a petfood. The wafer may be enrobed or moulded in the coating material which can be any of the usual coatings, for example a chocolate, compound, icing, caramel or combinations of these. Preferably the food product is a confectionery product.

Preferably, the maximum water activity of the food product at equilibrium is 0.65.

Since the wafers of the present invention maintain desired textural qualities such as crispness or brittleness at high water activities, the invention allows the production of novel confectionery wafer products with healthier fillings such as low-fat or low-calorie fillings, or new fillings such as caramel, fruit jam or a real fruit filling, where the wafer is in direct contact with the filling without the need of a moisture barrier.

### EXAMPLES

The following Examples further illustrate the present invention.

### Example 1

### Mechanical Assessment of Moisture Tolerance of Wafer

A batter was prepared having the following formulation:

| | |
|---|---|
| Flour | 100.0 parts |
| Water | 160.0 parts |
| Sucrose | 2.0 parts |
| Fat | 1.0 parts |
| Lecithin | 0.2 parts |
| Sodium bicarbonate | 0.2 parts |

Two fractions of the batter were prepared. 0.1 part of a commercial alpha-amylase, Validase BAA from Valley Research containing 1,200,000 Modified Wohlgemuth Units (MVVU) per gram, was added to one of the fractions (treated fraction). The other fraction, without addition of alpha-amylase, was used as reference (standard fraction).

Wafers were prepared to provide two types of wafers: one series of reference wafers without enzyme (standard) and one series of wafers treated with the alpha-amylase (treated). Wafers were prepared by baking the batters for 2 minutes in an oven (25-plate wafer oven, Hebenstreit Moerfelded, West Germany) between two metal plates heated to 130° C. After short cooling, samples were hydrated in climatic chambers at the desired water activity (Aw) for 15 days before mechanical testing. The Aw was measured in each sample after hydration to verify the correct hydration of the sample.

In order to assess the moisture tolerance of the wafers, a texture analyser able to record force/distance parameters during penetration of a probe into the wafer was used. The instrument forces a cylindrical probe into a stack of five wafers and the structural ruptures (force drops) are recorded. The frequency of force drops allows discrimination between wafer textures whereby the higher the number of force drops, the higher the crispiness.

The conditions used for this test were: Texture Analyser TA.HD, Stable Micro Systems, England; load cell 50 kg; 4 mm diameter cylinder stainless probe; penetration rate 1 mm/s; distance 8 mm; record of force drops greater than 0.2N; trigger force greater than 0.5N; acquisition rate 500 points per second.

The mechanical properties of the different wafers were analysed using a method based on the following 4 parameters which were used to characterise force-deformation curve.

Crispness Work, Wc (N.mm)

No; total number of peaks

d; distance of penetration (mm)

A; Area under the force-deformation curve (N.mm)

Changes in moisture tolerance may be associated to one of these parameters (crispiness work, Wc) which is defined as

$$Wc ( N \cdot mm ) = \frac{( A / d )}{( No / d )}$$

The equation may be simplified to Wc(N.mm)=A/No

The lower the value of Wc, the crisper the wafer. The lower the increase in Wc for a given increase in water activity, the greater the moisture tolerance.

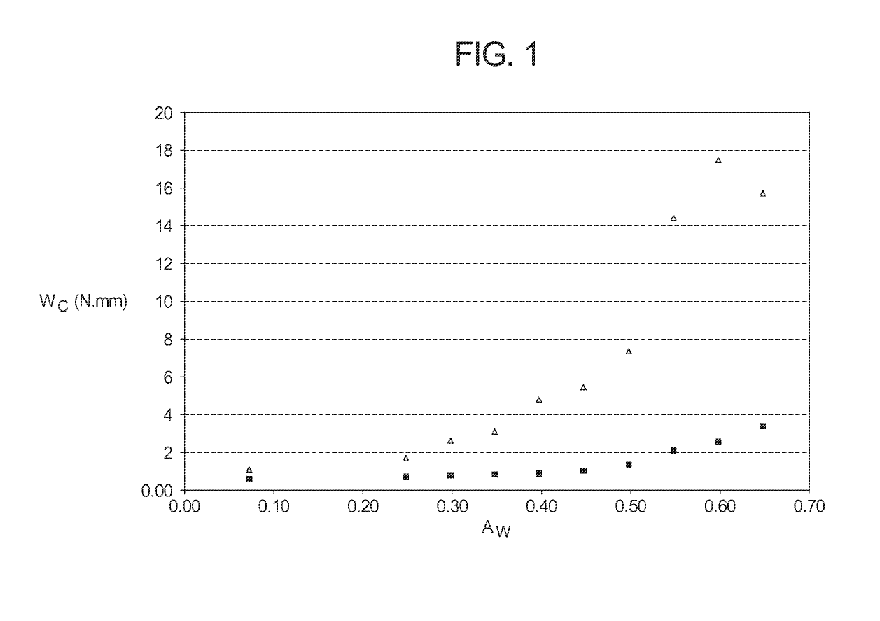

The wafer containing alpha-amylase (treated) shows improved moisture tolerance and crispness retention compared with the wafer not containing alpha-amylase (standard). This is illustrated in FIG. 1 where it can be seen that at a water activity of 0.3 the value of Wc is lower for the wafer containing alpha-amylase (treated), and for each increase of water activity of 0.1 of the wafer from a minimum value of water activity of 0.3, the Wc modification of the wafer containing alpha-amylase (treated) is less than 1 whereas the Wc modification of the wafer not containing alpha-amylase (standard) is greater than 1.5.

### Example 2

### Sensory Evaluation of Wafers

A batter comprising 780 g of wheat flour, 730 g of water and minor ingredients was treated for 30 min at 35° C. with a commercial enzyme blend containing protease and xylanase to obtain a suitable viscosity. 2 g of sodium bicarbonate were added to the mixture. Three fractions of batter were prepared. A commercial alpha-amylase, Validase BAA from Valley Research containing 1,200,000 Modified Wohlgemuth Units (MVVU) per gram and having an optimum temperature of activity of 65° C.-75° C. and an effective temperature of activity of up to 90° C. was added to 2 fractions at a level of 0.25 and 0.5 g/kg batter respectively. The third fraction, without addition of alpha-amylase, was used as reference. Wafers were prepared by baking the batters 2 min in an oven (Hebenstreit ZQE Mini) between two metal plates heated to 160° C. After short cooling, the wafers were either maintained in a sealed plastic bag (about 0.05 water activity) or equilibrated at 24° C. in dessicators containing saturated salt solutions (water activities: 0.22, 0.33, 0.43 and 0.53).

Ten trained panellists took part in the sensory evaluation. During the training sessions, a glossary of 9 attributes with descriptive terms was generated. Panellists were trained on scales with references until they understood all attributes and scored the products consistently.

The wafers were equilibrated for three weeks at different water activity levels (Aw 0.11, 0.22, 0.33 and 0.43) and presented in small glass jars (5 discs of 3 cm diameter per jar). Samples, coded with three-digit random code numbers, were evaluated under red lighting.

All products were profiled in a continuous scale from 0 to 10. Data were collected in sensory booths using Fizz® sensory analysis software and two replications were performed.

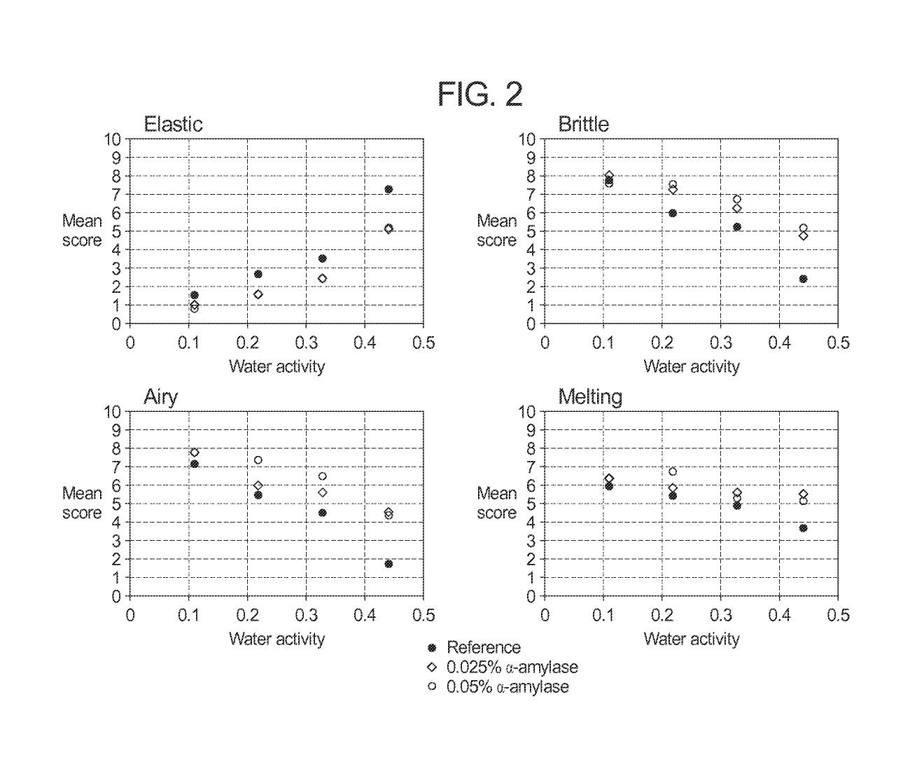

Main differences were perceived on the attributes elastic, brittle, airy and melting (FIG. 2). At low water activity (Aw 0.11) no difference between treated and reference wafers was perceived. At increasing water activities, the alpha-amylase treated wafers were judged as less elastic and more brittle than the reference wafers. This indicated that alpha-amylase treatment improved crispness retention of wafers when hydrated. Wafers prepared with alpha-amylase were also found less sensitive to hydration with regard to airy and melting rate attributes.

Attributes were defined as follows:

Elastic: Elasticity perceived when the wafer is pressed between the molar teeth without breaking it.

Brittle: Amount of particles formed while the wafer is crunched with the molar teeth. Assessed over the first crunch.

Airy: Aeration of the wafer when the wafer is chewed with the molar teeth. Assessed over the first three chews.

Melting rate: Melting of the wafer when pressed between the tongue and the palate. Assessed over the first three chews.

### Example 3

### Sensory Evaluation of Mixes (Wafer-Caramel Cream)

Wafers were prepared according to the method described in Example 2 to provide two types of wafers: 1 series of reference wafers without enzyme and 1 series of wafers treated with alpha-amylase (0.5 g/kg batter).

The wafers were cut into 3 cm diameter pieces (mean weight: 0.4 g) and allowed to equilibrate up to a constant weight for 3 weeks at 24° C. in a closed dessicator containing a saturated solution of magnesium chloride (relative humidity: 32.8%). Caramel cream (2.4 g; water activity 0.533) was layered between 2 wafer pieces and the resulting sandwiches were placed in small individual airtight jars. The jars were allowed to stand at 24° C. for 3 weeks in order to allow water to migrate from the cream to the wafers up to equilibrium (0.49 water activity).

Descriptive sensory data on texture were collected from a group of 6 of the trained panellists of Example 2. All assessors found a very significant difference between reference and alpha-amylase treated samples. These alpha-amylase treated samples were judged more crispy, brittle and less elastic than samples prepared without alpha-amylase. These products were considered by assessors as presenting a markedly more pleasant texture than that of the reference.

The invention is claimed as follows:

1. A no- or low sugar moisture resistant wafer, wherein at water activities from 0.3 to 0.6, an increase of 0.1 in water activity results in a We increase less than 1.5.

2. The wafer according to claim 1 comprising at least one component selected from the group consisting of proteinases and xylanases.

3. The wafer according to claim 1 wherein the wafer has a shape selected from the group consisting of a flat wafer and a three dimension shaped wafer.

4. The wafer according to claim 1 wherein the wafer contains from 0 to 8% by weight of sweetener based on the weight of the wafer.

5. The wafer according to claim 1 wherein the wafer contains from 0 to 5% by weight of sweetener based on the weight of the wafer.

6. The wafer according to claim 1 comprising a thermostable alpha-amylase and in-situ modified starch.

7. The wafer according to claim 6 wherein the amount of thermostable alpha-amylase incorporated into a batter from which the wafer is made is from 0.0005% to 1.0% by weight based on the total weight of the batter

8. The wafer according to claim 6 wherein the alpha-amylase is of an origin selected from the group consisting of bacterial, fungal, animal, and plants origin.

9. The wafer according to claim 1 which contains no high molecular weight starch hydrolysate.

10. The wafer according to claim 1 wherein the wafer contains less than 4.0% by weight of edible fat or oil based on the weight of the wafer.

11. The wafer according to claim 1 wherein the wafer contains less than 2.0% by weight of edible fat or oil based on the weight of the wafer.

12. A process for making a moisture-resistant wafer comprising the steps of mixing at least flour, water and a thermostable alpha-amylase and baking it on at least one hot surface to produce a batter.

13. A food product comprising a no- or low sugar moisture-resistant wafer in contact with another food material, wherein at water activities from 0.3 to 0.6, an increase of 0.1 in water activity results in a We increase less than 1.5.

14. The food product according to claim 13 wherein the other food material is selected from the group consisting of a confectionery, savoury and petfood material.

15. The food product according to claim 14 wherein the confectionery material is selected from the group consisting of chocolate, jelly, compound chocolate, ice-cream, sorbet, nut paste, cream, cream-based products, cake, mousse, nougat, caramel, praline, jam, wafer rework and combination of these ingredients with or without inclusions of the same ingredient in a different state or of a different ingredient.

16. The food product according to claim 14 wherein the savoury material is selected from the group consisting of fish, meat paste, cheese-based materials and vegetable puree.

17. The food product according to claim 13 wherein one or more of the other food materials is included as a filling for the wafer.

18. The food product according to claim 17 wherein the other food material is a confectionery material and is selected from the group consisting of a low-fat or low-calorie filling, a fruit jam and a real fruit filling.

19. The food product according to claim 13 wherein the wafer is the center or part of the center of a product selected from the group consisting of confectionery, savoury product and a petfood.

20. The food product according to claim 13 wherein the wafer is in direct contact with the food material in the absence of a moisture barrier.

21. The food product according to claim 13 wherein a moisture barrier is present between the wafer and the confectionery material.

22. The food product according to claim 13 wherein the other food material has a high water activity.

23. The food product according to claim 13 wherein the maximum water activity of the product at equilibrium is 0.65.

24. A method for exhibiting moisture resistance and maintaining crispiness in a wafer comprising using a wafer wherein at water activities from 0.3 to 0.6, an increase of 0.1 in water activity results in a We increase less than 1.5.

25. The moisture-resistant wafer according to claim 1 which contains no crystalline hydrate former.
